(19) United States
(12) Patent Application Publication
(10) Pub. No.: US 2024/0139044 A1
(43) Pub. Date: May 2, 2024

(54) SLEEPING BAG CAPABLE OF BEING A STRETCHER

(71) Applicant: Fatih DIREKCI, ANTALYA (TR)

(72) Inventor: Fatih DIREKCI, ANTALYA (TR)

(21) Appl. No.: 18/557,821

(22) PCT Filed: Apr. 19, 2022
(86) PCT No.: PCT/TR2022/050346

§ 371 Date: Oct. 27, 2023

(30) Foreign Application Priority Data
Apr. 21, 2021 (TR) 2021/007211

(51) Int. Cl. A61G 1/01; A47G 9/08; A61G 1/044

(52) U.S. Cl. CPC A61G 1/01; A47G 9/086; A61G 1/044

(57) ABSTRACT

The disclosure relates to a sleeping bag capable of being a stretcher designed for use in civilian and military fields. The sleeping bag includes a gripping arm formed as an integral part, which is provided three on the right side and three on the left side, a pulling arm formed on a liner of the gripping arm on a nape area, at least one belt fastened to the fabric so as to provide immobilization from a head, torso, and foot areas of a body, and two handling arms located so as to surround the stretcher thoroughly as one piece.

### TECHNOLOGICAL FIELD

The present disclosure relates to a sleeping bag capable of being a stretcher designed for use in civilian and military fields.

### BACKGROUND

A sleeping bag is a type of a light insulated duvet which allows a person to warm up with his/her own body heat while lying down and is able to be opened and closed by a zipper or a similar means. This is used as a portable bedding in cases where a person sleeps in an external environment, for example during camping, hiking and climbing.

Sleeping bags are an important equipment not only in the civilian sense but also in the military sense. It is an article acting as field equipment, especially for officers, sergeants and soldiers of the Armed Forces. Sleeping bags are an equipment which should be always carried by the soldiers so as not to be affected by climatic events such as cold, rain and snow while sleeping, as they are constantly on duty outside of their place of residence. Apart from the sleeping bag, another equipment that is especially important for military personnel as well as civilians is a stretcher. Sending soldiers to hospitals, who are injured as a result of bullets or rockets hitting the body, shrapnel pieces ricocheting off explosive weapons such as howitzers, hand grenades, or a rollover of a personnel delivery vehicle due to the site conditions is important. Especially in cases of fractures, dislocations, cracks and similar injuries, the immobile transportation of the wounded person will prevent further damage to that person, thereby preventing accidents which may occur during transportation. Recently, military operations such as Operation Olive Branch, Operation Peace Spring, Operation Euphrates Shield and Operation Afrin have shown how important the stretcher is. However, carrying both the sleeping bag and the stretcher by a military personnel will increase the burden of the personnel, limit their mobility and cause them to get tired quickly. Therefore, there is a need for a new technology which combines a stretcher and a sleeping bag.

A utility model application no.TR200607424 discloses “A Sleeping Bag Retaining Body Temperature”. This invention is made from a raised two-thread or raised three-thread fabric and a cotton fabric. The production method of the invention is as follows: patterns are prepared depending on the nature of the article to be produced (children, men, women, etc.). The raised two-thread or raised three-thread fabric and the cotton fabric are cut according to the patterns. The cut parts are joined together. The feet, sleeve and collar parts of the sleeping bag are sewn from a rib fabric and mounted on the sleeping bag. The size of the zipper is determined depending on the zipper part on the sleeping bag, and the zipper is sewn on, and mounted to, the front part of the sleeping bag. The article is ironed out and made ready for use.

The utility model application no.TR200810075 discloses “A zippered blanket capable of being a sleeping bag”. This invention is particularly related to a zippered blanket capable of being a sleeping bag to be used for infants and children, characterized in that it consists of a rectangular blanket comprising a zipper on opposing two sides thereof, which does not extend up to top, upper snap fasteners on the sides following the zipper and lower snap fasteners arranged on the lower side, which overlap when it is folded over a folding area.

The above inventions refer to currently commercially available sleeping bags. These sleeping bags are nor capable of being a stretcher. Therefore, the above-mentioned inventions cannot overcome the existing shortcomings.

### SUMMARY

One object of the disclosure is to provide a structure which is capable of being both a stretcher and a sleeping bag. Producing the sleeping bag from an insulated material allows a person to maintain the body temperature. Fastening the inner liner structures of the stretcher on the fabric in an integral manner increases the strength of the stretcher during the transport of a wounded person. Furthermore, at least one embodiment of the invention is 1700 gr and is substantially light and durable as compared to the current counterparts thereof.

The stretcher mentioned in at least one embodiment of the invention offers an opportunity to transport a wounded person in more than one way. The first of these is the process of carrying the wounded person together by the personnel located on the right and left of the stretcher, by holding the gripping arms. A pulling arm is used to pull vertically. The second one is the process of carrying the wounded person with the head and body up and hips and feet down, by placing the handling arm on his shoulders, if only one person is required to carry the wounded person. The third one is the transportation by a helicopter. The gripping arms are associated with cords or ropes, and the wounded person is carried by clamps. In addition, another advantage of at least one embodiment of the invention during the transportation of the wounded person by a helicopter is that it enables the transportation of not only one but more than one wounded person. The stretchers may be connected to each other by the gripping arms, so that more than one wounded person may be transported by a helicopter at once by the clamps.

At least one embodiment of the invention has sleeve parts as compared to the current counterparts thereof. The reason is to enable military personnel to use their limbs (taking items, holding/carrying weapons, etc.). In addition, the personnel is allowed to stand and walk as the zipper structure is able to be opened from the bottom to the up.

### BRIEF DESCRIPTION OF THE FIGURES

The invention will be described with reference to the accompanying drawings, so that the features of the invention will be more clearly understood and appreciated, but it is not intended to limit the invention to these particular embodiments. On the contrary, it is intended to cover all alternatives, modifications and equivalents of the invention which may be included within the scope of the invention as defined by the appended claims. It should be understood that the details shown are only for illustration of the preferred embodiments of the invention, and are presented for the purpose of providing the most useful and easy-to-understand description of both the embodiment of the methods and the rules and conceptual features of the invention. In the figures:

FIG. 1 is a view of the front body of the article of at least one embodiment of the invention.

FIG. 2 is a view of the rear body of the article of at least one embodiment of the invention.

FIG. 3 is a view of an arrangement of the inner liner of the article of at least one embodiment of the invention.

FIG. 4 is a view of the patterns (a fly, a front body, a hoodie, a forefoot) forming the front body of the article of at least one embodiment of the invention.

FIG. 5 is a view of the patterns (an upper back body, a lower back body, a right and left sleeve, a rear foot) forming the back body of the article of at least one embodiment of the invention.

FIG. 6 is a view of the articles of at least one embodiment of the invention, during the transportation by a helicopter by means of a clamp by being combined side by side.

### DETAILED DESCRIPTION

The figures which will help to understand the embodiments of the invention are numbered as indicated in the attached drawings and are given below with their names.
1. Sleeping bag
   1.1. Gripping arm
   1.2. Pulling arm
   1.3. Belt
   1.4. Handling arm
   1.5. Snap fastener
   1.6. Zipper
2. Clamp
   K. Patterns

At least one embodiment of the invention comprises a gripping arm 1.1 formed as an integral part, which is provided three on the right side and three on the left side, a pulling arm 1.2 formed on a liner of the gripping arm 1.1 on a nape area, at least one belt 1.3 fastened to the fabric so as to provide immobilization from a head, torso and foot areas of a body, and two handling arm 1.4 located so as to surround the stretcher thoroughly as one piece.

The belt 1.3 in at least one embodiment of the invention is configured in the inner liner so as to allow a wounded person to be carried in a stable way. At least one embodiment of the invention has a clamp 2 which enables a wounded person to be transported by a helicopter upon connection of the stretchers via the gripping arm 1.1 parts by joining them side by side. The sleeping bag 1 mentioned in at least one embodiment of the invention contains at least one snap fastener 1.5 on its inner and outer parts. The sleeping bag 1 mentioned in at least one embodiment of the invention has a zipper 1.6 which allows the front part of the sleeping bag to be opened up from bottom towards the top.

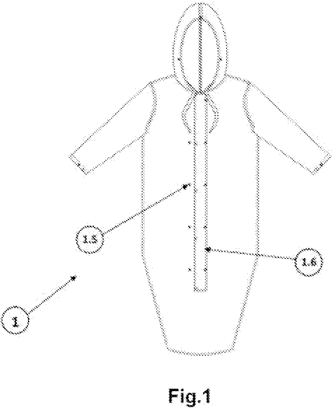

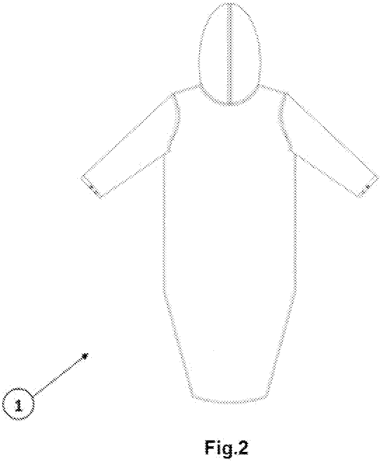

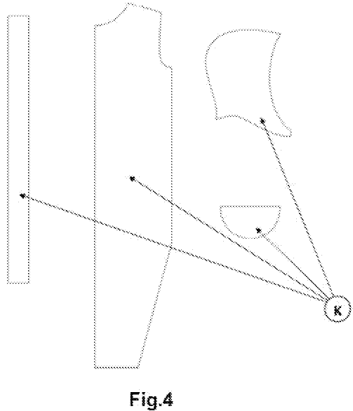

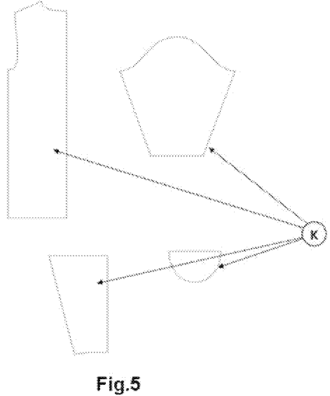

FIGS. 1-2 shows the sleeping bag 1 capable of being a stretcher according to at least one embodiment of the invention. The at least one embodiment of the invention in this figure is used as a sleeping bag 1 as in that figure. The parts forming the pattern K structures of the article according to at least one embodiment of the invention are as follows: sleeves, an upper front body, a lower fly of the front body, an upper rear body, a lower rear body, a hoodie and a foot part (FIGS. 4-5). The weight of the model in the form of a ready-to-delivery structure with all its accessories thereon is 1700 gr. The zipper 1.6 structure in the sleeping bag 1 seen in FIG. 1 is opened from the bottom to the top. The reason for this is to ensure the personnel to be able to stand in the sleeping bag 1 without getting out completely. In addition, the sleeping bag 1 has sleeve parts so that the soldier can hold a weapon.

The sleeping bag 1 according to at least one embodiment of the invention will be 1.50 meters in width with a quilted stitching, with the outer part being a polyester fabric, and the liner part being a knitted fabric to keep warmer. 200 grams of silicon fiber will be used in the inner filling of the fabric. A thin interlining will be present between the fabric and the fiber on both sides. A total of 3.20 meters of fabric will be used for making the model. The model will be sewn with the fabric by a polyester yarn with a count of 35 and 50 in a tone-in-tone manner. While sewing the sleeping bag 1, the seams remaining inside will be cleaned with a herringbone polyester piping of 2 cm in a tone-in-tone manner with a specially produced fabric. A total of 15 meters of piping will be used for the whole body. 1 zipper with a metal glider and thick teeth will be used in tone-in-tone with the fabric on the sleeping bag 1. The vertical zipper will have a double-sided mechanism and will open completely.

Laces of 120 cm in a color compatible with the body will be used inside the hood of the sleeping bag 1. The laces will be fixed inside the hoodie so as to prevent the hoodie from shrinking, so that it can be used comfortably and not get out of the hoodie. On the sleeping bag 1, YKK's system 61 metal snap fasteners 1.5 of 1.5 cm will be used, which are specially produced and coated. A total of 10 YKK's snap fasteners 1.5 are used on the model.

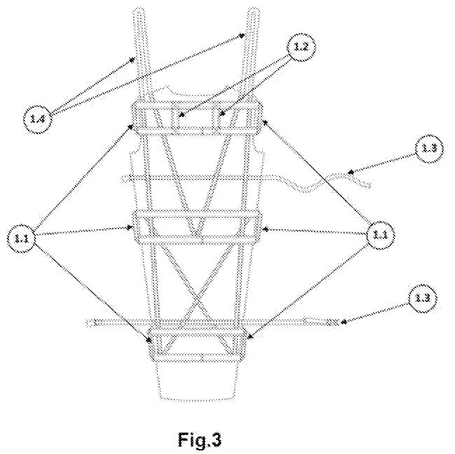

FIG. 3 shows the inner liner arrangement of the sleeping bag 1. On the sleeping bag, there are gripping arms 1.1 which are provided three on the right side and three on the left side. The gripping arms 1.1 have a maximum strength as they are integral. 1 pulling arm 1.2 is present on the nape part to pull the sleeping bag vertically. Belts 1.3 are included in the article, so that the wounded person may be fastened on the stretcher by the head, body and foot parts. There are provided handling arms 1.4 which are hidden on the shoulder and enables one person to carry a wounded person on his shoulder draggingly, with the head and body up and hips and feet down, when needed, wherein the handling arms distribute the weight equally to each point of the stretcher and maximizes the strength of the stretcher, as they surround the stretcher thoroughly as one piece. The stretcher and the gripping arm 1.1, pulling arm 1.2, the belt 1.3 and handling handles 1.4 thereon may be exposed by opening the zipper.

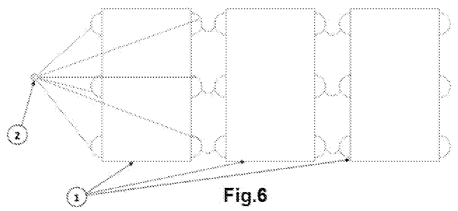

FIG. 6 shows the sleeping bags 1 which are in the form of stretchers, are lined up side by side and connected to each other. In addition, the clamp 2 is associated with the stretcher and the wounded person is transported by a helicopter.

1. A sleeping bag capable of being a stretcher, comprising:
a gripping arm formed as an integral part, which is provided three on the right side and three on the left side,
a pulling arm formed on a liner of the gripping arm on a nape area,
at least one belt fastened to the fabric so as to provide immobilization from a head, torso, and foot areas of a body, and
two handling arms located so as to surround the stretcher thoroughly as one piece.

2. The sleeping bag capable of being a stretcher according to the claim 1, wherein the at least one belt is provided on an inner liner so as to carry a wounded person in a stable manner.

3. The sleeping bag capable of being a stretcher according to the claim 1, further comprising a clamp connected from the gripping arm portions.

4. The sleeping bag capable of being a stretcher according to the claim 1, wherein the gripping arm is used during coupling of the stretchers next to each other.

5. The sleeping bag capable of being a stretcher according to the claim 1, further comprising at least one snap fastener both on inner and outer parts.

6. The sleeping bag capable of being a stretcher according to the claim 1, further comprising a zipper which allows the front part of the sleeping bag to be opened up from bottom towards the top.
